(19) United States
(12) Patent Application Publication
(10) Pub. No.: US 2018/0042388 A1
(43) Pub. Date: Feb. 15, 2018

(54) AUTOMATED WALL BED

(71) Applicant: 154322 CANADA INC., Anjou (CA)

(72) Inventor: Patrick RUBANO, Anjou (CA)

(21) Appl. No.: 15/551,384

(22) PCT Filed: Feb. 16, 2016
(86) PCT No.: PCT/CA2016/000075

§ 371 Date: Aug. 16, 2017

Related U.S. Application Data
(60) Provisional application No. 61/116,646, filed on Nov. 21, 2008.

(51) Int. Cl. A47C 17/48; G01G 19/414

(52) U.S. Cl. CPC A47C 17/48; G01G 19/4142

(57) ABSTRACT

An automated wall bed comprises a movable support defining opposite lateral sides and head and foot ends for supporting a mattress thereon, A movement imparting device provides for moving the movable support between a folded up position and a folded down position. A bracket assembly is mounted to each later side of the movable support and in communication with the movement imparting device and comprises a strength-adjustment device comprising springs for storing mechanical energy. When moving the movable support between the folded up and folded down positions, the strength-adjustment device provides mechanical energy to the movement imparting device, thereby providing for less mechanical energy to be used by the movement imparting device. A sensor provides for sensing a predetermined weight on the mattress. A controller is in communication with the movement imparting device and the sensor for receiving the weight amount detected by the sensor and for controlling the movement imparting device based on the detected weight, The controller provides for stopping the movement imparting device from moving the movable support from the folded down position to the folded up position when the predetermined weight is detected.

### CROSS-REFERENCE TO RELATED APPLICATIONS

The present application claims priority on U.S. Provisional Patent Application No. 62/116,646 filed on Feb. 16, 2015 and incorporated herein by reference in its entirety.

### TECHNICAL FIELD

The present disclosure relates to beds. More particularly, but not exclusively, the present disclosure relates to an automated wall bed.

### BACKGROUND

A murphy bed, a wall bed, a pull down bed or a fold-down bed is a bed that is hinged at one end to store vertically against the wall, or inside of a closet or cabinet. Most wall beds do not have box springs. Instead, the mattress usually lies on a wood platform or wire mesh, and is held in place so as not to sag when in a closed position. The mattress is attached to the bed frame, often with elastic straps to hold the mattress in position when the unit is folded upright. When attempting to pull a wall bed down from the wall, it is possible that it could collapse on the user. Automated wall beds, are known. Some automated beds are mechanically complex structures with many movable parts that are not easily accesses for curving a mattress via a conveyor within a wall supported enclosure. Other automated wall beds use an actuator to move pull the bed up or bring it down, these actuators use excessive amounts of force that pushes the bed quickly and hard onto the floor which can cause properly damage or a physical accident. Furthermore, automated beds may also fold up into the closet or cabinet with a child or animal that unknowingly mounts the bed during unsupervised lifting.

### OBJECTS

An object of the present disclosure is to provide an automated wall bed.

An object of the present disclosure is to provide a kit of an automated wall bed.

An object of the present disclosure is to provide a device for assisting the movement of an automated wall bed.

An object of the present disclosure is to provide a device for imparting a movement to an automated wall bed.

An object of the present disclosure is to provide a device for modulating the movement of an automated wall bed.

An object of the present disclosure is to provide a method for assisting the movement of an automated wall bed.

An object of the present disclosure is to provide a method for modulating the movement of an automated wall bed.

### SUMMARY

In accordance with an aspect of the disclosure there is provided an automated wall bed comprising: a movable support defining opposite lateral sides and head and foot ends for supporting a mattress thereon; a movement imparting device for moving the movable support between a folded up position and an folded down position; a bracket assembly mounted to each later side of the movable support and in communication with the movement imparting device, the bracket assembly comprising a strength-adjustment device comprising springs for storing mechanical energy, wherein when moving the movable support between the folded up and folded down positions, the strength-adjustment device provides mechanical energy to the movement imparting device, thereby providing for less mechanical energy to be used by the movement imparting device.

In an embodiment, the automated wall bed defined above further comprises: a sensor for sensing a predetermined weight on the mattress; and a controller in communication with the movement imparting device and the sensor for receiving the weight amount detected by the sensor and for controlling the movement imparting device based on the detected weight, wherein the controller provides for stopping the movement imparting device from moving the movable support from the folded down position to the folded up position when the predetermined weight is detected.

In accordance with an aspect of the present disclosure, there is provided an automated wall bed comprising: a movable support defining opposite lateral sides and head and foot ends for supporting a mattress thereon; a movement imparting device for moving the movable support between a folded up position and an folded down position; a sensor for sensing a predetermined weight on the mattress; and a controller in communication with the movement imparting device and the sensor for receiving the weight amount detected by the sensor and for controlling the movement imparting device based on the detected weight, wherein the controller provides for stopping the movement imparting device from moving the movable support from the folded down position to the folded up position when the predetermined weight is detected.

In an embodiment, the automated wall bed as defined above further comprises: a bracket assembly mounted to each later side of the movable support and in communication with the movement imparting device, the bracket assembly comprising a strength-adjustment device comprising springs for storing mechanical energy, wherein when moving the movable support between the folded up and folded down positions, the strength-adjustment device provides mechanical energy to the movement imparting device, thereby providing for less mechanical energy to be used by the movement imparting device.

In an embodiment of any one of the automated wall beds as defined above, the strength-adjustment device provides for modulating the amount of mechanical energy provided to the movement imparting device by increasing or decreasing the tension on the springs.

In accordance with an aspect of the present disclosure, there is provided a kit for an automated wall bed comprising: a movable support defining opposite lateral sides and head and foot ends for supporting a mattress thereon; a movement imparting device for moving the movable support between a folded up position and an folded down position; a bracket assembly for being mounted to each later side of the movable support and in for being placed in communication with the movement imparting device, the bracket assembly comprising a strength-adjustment device comprising springs for storing mechanical energy, wherein when moving the movable support between the folded up and folded down positions, the strength-adjustment device provides mechanical energy to the movement imparting device, thereby providing for less mechanical energy to be used by the movement imparting device.

In an embodiment, the kit for an automated wall bed as defined above, further comprises: a sensor for sensing a predetermined weight on the mattress; and a controller for being placed in communication with the movement imparting device and the sensor for receiving the weight amount detected by the sensor and for controlling the movement imparting device based on the detected weight, wherein the controller provides for stopping the movement imparting device from moving the movable support from the folded down position to the folded up position when the predetermined weight is detected.

In accordance to an aspect of the present disclosure, there is provided a kit for an automated wall bed comprising: a movable support defining opposite lateral sides and head and foot ends for supporting a mattress thereon; a movement imparting device for moving the movable support between a folded up position and an folded down position; a sensor for sensing a predetermined weight on the mattress; and a controller for being placed in communication with the movement imparting device and the sensor for receiving the weight amount detected by the sensor and for controlling the movement imparting device based on the detected weight, wherein the controller provides for stopping the movement imparting device from moving the movable support from the folded down position to the folded up position when the predetermined weight is detected.

In an embodiment, the kit for an automated wall bed as defined above, further comprises: a bracket assembly for being mounted to each later side of the movable support and in communication with the movement imparting device, the bracket assembly comprising a strength-adjustment device comprising springs for storing mechanical energy, wherein when moving the movable support between the folded up and folded down positions, the strength-adjustment device provides mechanical energy to the movement imparting device, thereby providing for less mechanical energy to be used by the movement imparting device.

In an embodiment of any one of the kits of an automated wall bed as defined above, the strength-adjustment device provides for modulating the amount of mechanical energy provided to the movement imparting device by increasing or decreasing the tension on the springs.

In accordance with an aspect of the disclosure, there is provided a device for assisting the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the device comprising: a bracket assembly mounted to each later side of the movable support and in communication with the movement imparting device; and a strength-adjustment device in communication with the bracket assembly comprising springs for storing mechanical energy, wherein when moving the movable support between the folded up and folded down positions, the strength-adjustment device provides mechanical energy to the movement imparting device, thereby providing for less mechanical energy to be used by the movement imparting device.

In an embodiment of the device defined above, the strength-adjustment device provides for modulating the amount of mechanical energy provided to the movement imparting device by increasing or decreasing the tension on the springs.

In accordance with an aspect of the present disclosure, there is provided a device for imparting a movement to an automated wall bed between folded up and folded down positions, the automated wall bed comprising a movable support defining opposite lateral sides and head and foot ends for supporting a mattress thereon, the device comprising: an actuator; a bracket assembly mounted to each later side of the movable support and in communication with the actuator; and a strength-adjustment device in communication with the bracket assembly comprising springs for storing mechanical energy, wherein when moving the movable support between the folded up and folded down positions, the strength-adjustment device provides mechanical energy to the actuator, thereby providing for less mechanical energy to be used by the movement imparting device.

In an embodiment of the device described above, the strength-adjustment device provides for modulating the amount of mechanical energy provided to the actuator by increasing or decreasing the tension on the springs.

In accordance with an aspect of the present disclosure, there is provided a device for modulating the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the device comprising: a sensor for sensing a predetermined weight on the mattress; and a controller for being placed in communication with the movement imparting device and the sensor for receiving the weight amount detected by the sensor and for controlling the movement imparting device based on the detected weight, wherein the controller provides for stopping the movement imparting device from moving the movable support from the folded down position to the folded up position when the predetermined weight is detected.

In an embodiment of any of the automated beds, kits and devices defined above, the movement imparting device comprises a pair of actuators and the bracket assembly comprises a pair of bracket device, each bracket device being mounted to a respective lateral side of the movable support, each actuator being mounted to a respective bracket assembly. In an embodiment, each bracket device comprises a panel with springs mounted thereto, the strength adjustment device comprising a plate assembly being mounted to the springs, the plate assembly being selectively movable for stretching the springs so as to add tension thereto thereby storing additional mechanical energy. In an embodiment, the plate assembly comprises a pair of plate members, each plate member is mounted to a respective opposite end of the springs, at least one of the plate members being movable along the panel for stretching the springs. In an embodiment, the strength adjustment device comprises an actuator provides for selectively moving the plate assembly so as to selectively adjust the tension of the springs. In an embodiment, the actuator comprises a threaded screw within a tubular socket of the plate assembly, the tubular socket being complementary threaded so that turning of the screw causes the tubular socket to move along the length of the screw thereby moving the plate assembly.

In accordance with an aspect of the present disclosure, there is provided a method for assisting the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the method comprising: storing mechanical energy in springs positioned on a support member; placing the support member with the springs in communication with the movement imparting device and the movable support so as to transfer the mechanical energy to the movement imparting device, thereby providing for less mechanical energy to be used by the movement imparting device.

In an embodiment, of the method above described above, further comprises: selectively adjusting the tension on the springs so as to modulate the amount of mechanical energy provided to the movement imparting.

In accordance with an aspect of the present disclosure, there is provided a method for modulating the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the method comprising: automatically sensing the weight on the mattress; automatically comparing the sensed weight with a predetermined weight; automatically stopping the movement imparting device from moving the movable support from the folded down position to the folded up position when the predetermined weight is detected.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective front view of the automated wall bed in accordance with a non-restrictive illustrative embodiment of the present disclosure in a folded down position;

FIGS. 2a, 2b and 2C are perspective close-up views of the movement imparting device for the automated wall bed of FIG. 1;

FIG. 3 is a perspective front view of the automated wall bed in a folded up position;

FIG. 4 is perspective close-up view of the movement imparting device for the automated wall bed of FIG. 3;

FIG. 5 is disassembled perspective view of the strength adjustment device of the bracket assembly of movement imparting device of FIGS. 2a, 2b, 2c and 4;

FIG. 6 is an exploded perspective view of the strength adjustment device of FIG. 5;

FIG. 7 is a perspective view of the bracket supports of the bracket assembly of the movement imparting device of FIGS. 2a, 2b, 2c and 4; and

FIG. 8 is a schematic representation of a device for modulating the movement of an automated wall bed.

### DETAILED DESCRIPTION

Generally stated and in accordance with an embodiment, there is provided an automated wall bed comprising a movable support defining opposite lateral sides and head and foot ends for supporting a mattress thereon. A movement imparting device provides for moving the movable support between a folded up position and a folded down position. A bracket assembly is mounted to each later side of the movable support and in communication with the movement imparting device. The bracket assembly comprises a strength-adjustment device comprising springs for storing mechanical energy. When moving the movable support between the folded up and folded down positions, the strength-adjustment device provides mechanical energy to the movement imparting device, thereby providing for less mechanical energy to be used by the movement imparting device.

Generally stated, there is provided an automated wall bed comprising a sensor for sensing a predetermined weight on the mattress. A controller is in communication with the movement imparting device and the sensor for receiving the weight amount detected by the sensor and for controlling the movement imparting device based on the detected weight. The controller provides for stopping the movement imparting device from moving the movable support from the folded down position to the folded up position when the predetermined weight is detected.

With reference, to the appended Figures, non-restrictive illustrative embodiments will be herein described so as to further exemplify the disclosure only and by no means limit the scope thereof.

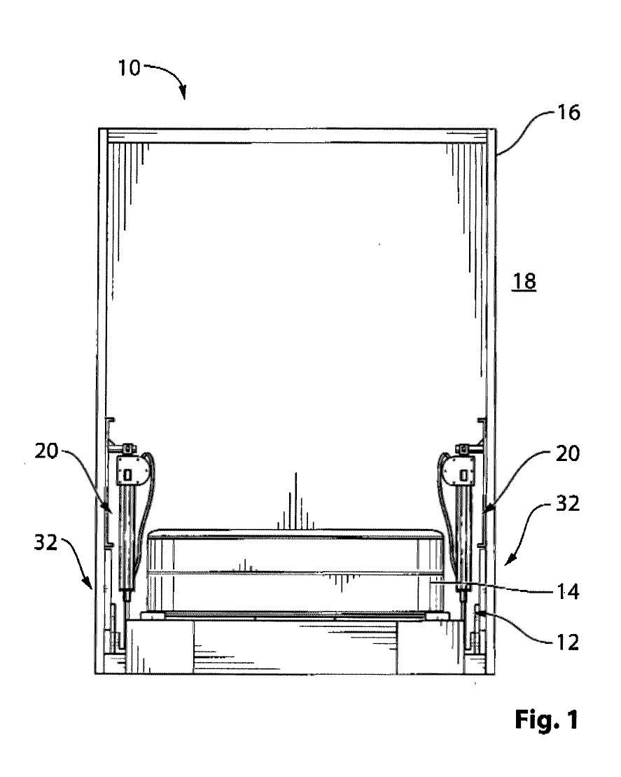

FIG. 1 shows an automated wall bed 10 in a folded down position ready for use. The automated wall bed is shown including a movable support 12 with a mattress 14 thereon, a wall cabinet 16 mounted to a wall 18 and a movement imparting device 20.

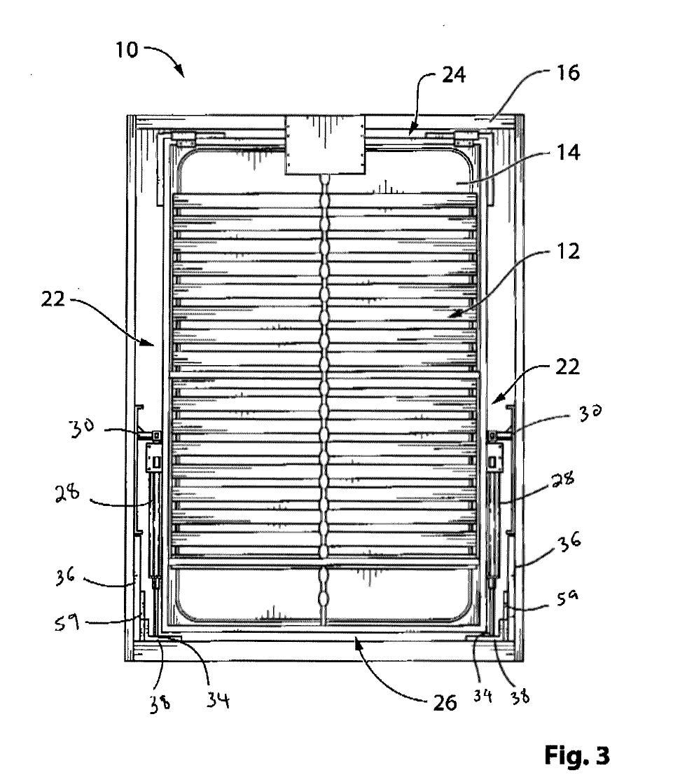

FIG. 3 shows the automated wall bed in the folded up position with movable support 12 and the mattress 14 in a vertical position within the wall cabinet 16. The movable support 12 includes lateral sides 22 and head and foot ends, 24 and 26, respectively.

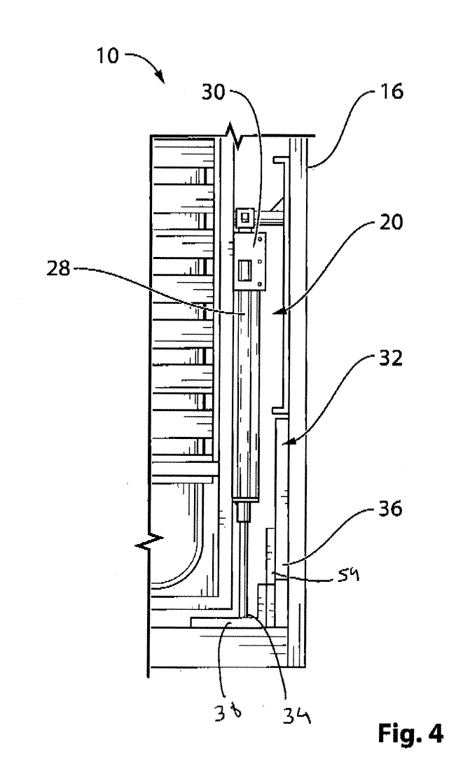

With respect to FIGS. 1, 2a-2c and 4, the movement imparting device 20 comprises a pair of actuators 28 each mounted to the wall cabinet 16 at one end 30 thereof and each being respectively connected the bracket assembly 32 at the opposite end 34 thereof. The bracket assembly 32 comprises a pair of bracket devices 36, each mounted to a respective lateral side 22 of the movable support 12. Each actuator 28 is mounted to a respective bracket device 36 at its end 34.

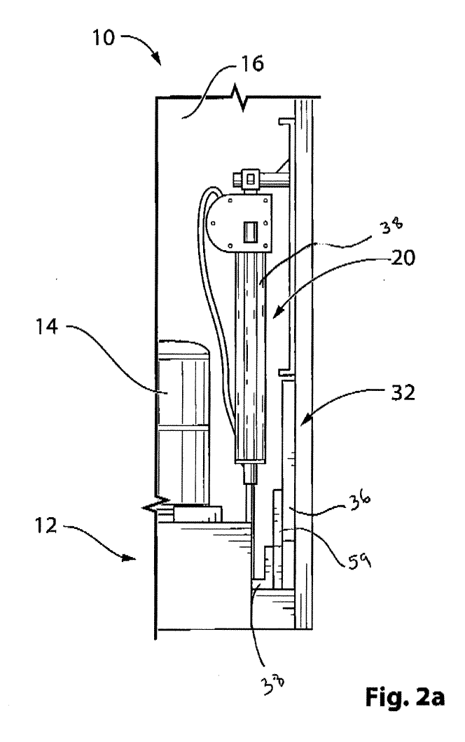

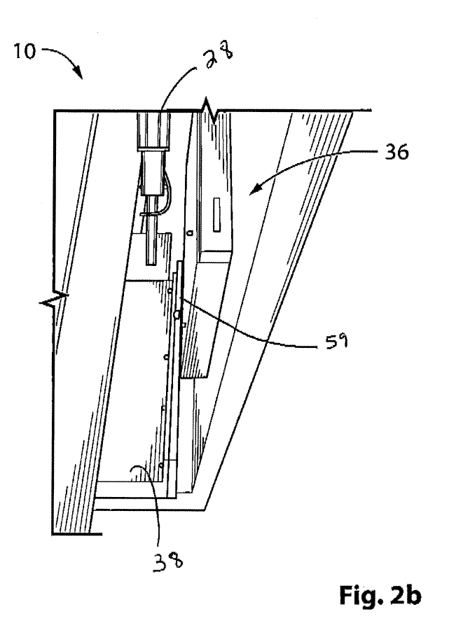

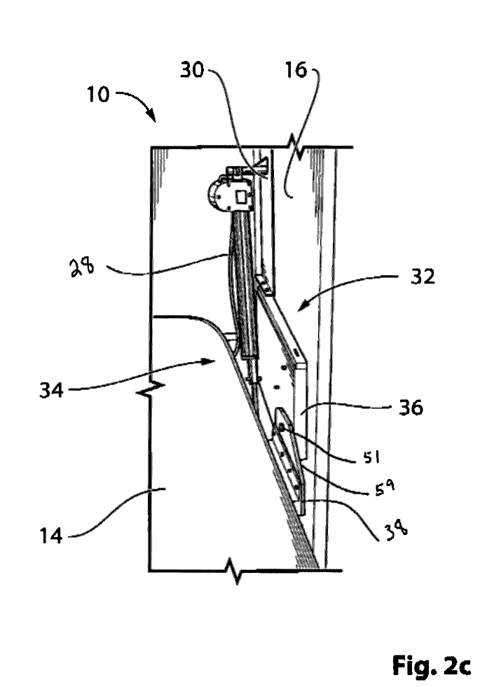

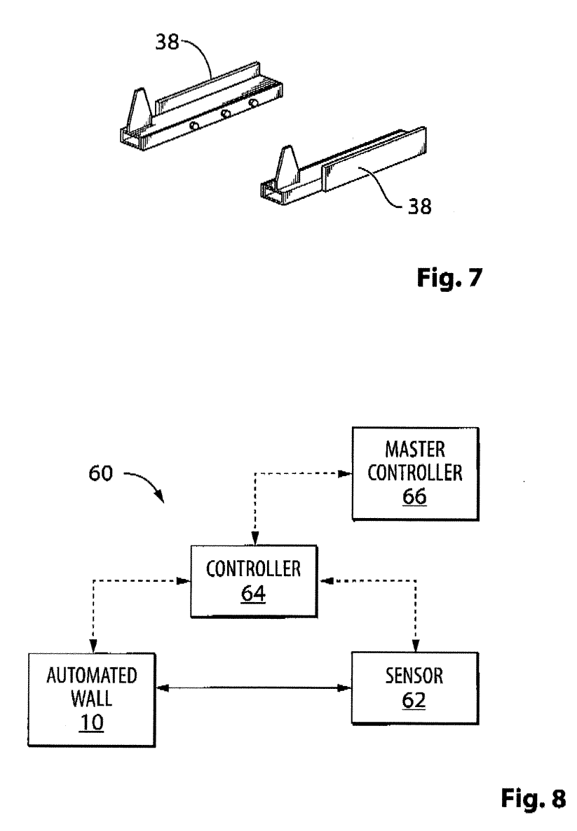

The actuator 28 is a piston and rod structure that extends when moving the bed 10 to the folded down position and retracts when moving the bed to the folded up position. Each end 34 of each actuator 28 is connected to a respective bracket member 38 (see FIGS. 2b, 2c and 7) of the bracket device 36 which in turn is mounted to the frame of the movable support 12 proving the actuators 28 to impart a movement to the movable support 12.

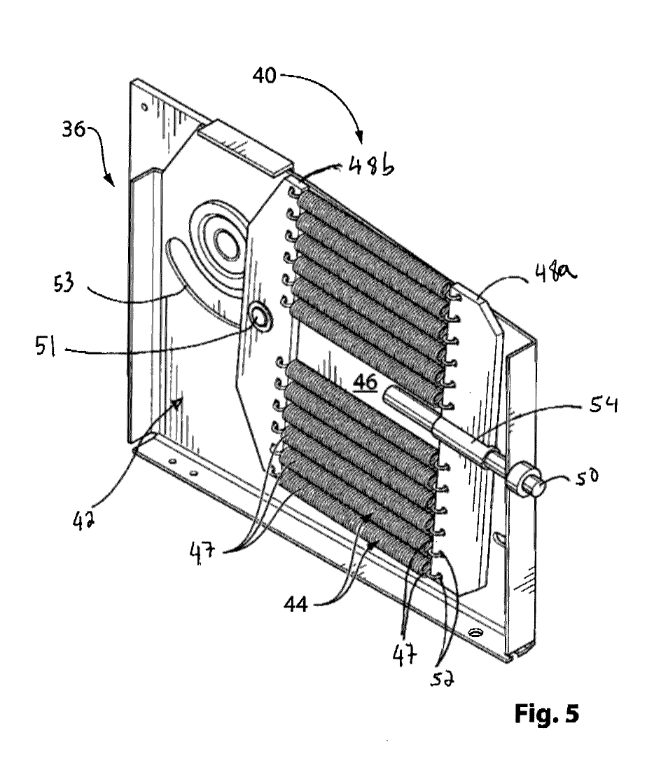

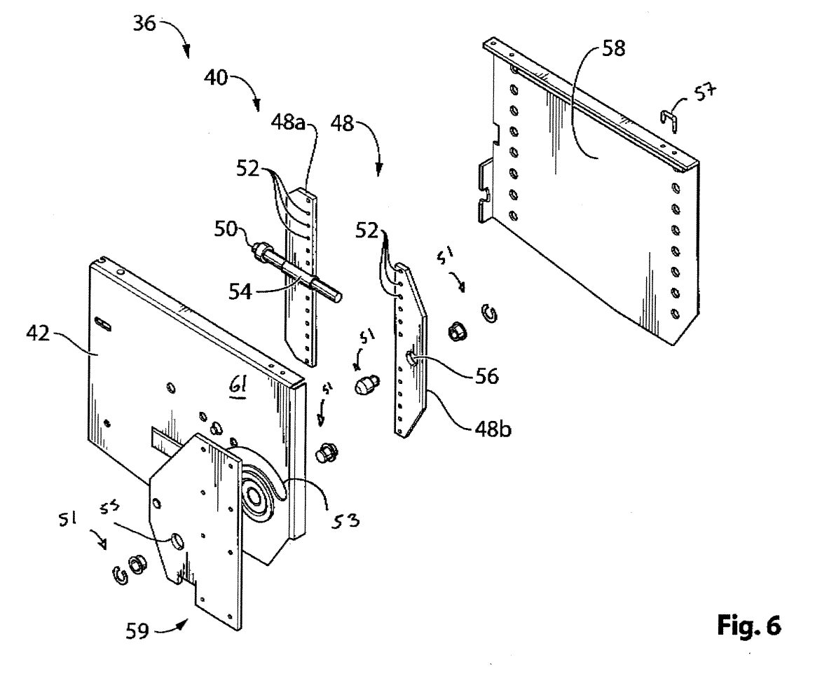

The bracket devices 36 include a strength adjustment device or cluster 40 better shown in FIGS. 5 and 6.

The device 40 includes a panel 42 with springs 44 mounted thereto. The panel 42 is mounted to the well cabinet 16. The springs 44 rest on the flat inner surface 46 of the panel and are mounted to plate assembly 48. More particularly, the springs are mounted at each longitudinal end 47 thereof to a respective plate member 48a and 48b. Each plate 48a and 48b Includes holes 52 for receiving a free end 47 of a spring 44. At least one of the plate members (In this case 48a) is movable along the inner surface 46 by way of an actuator 50 moving the plates 48a and 48b apart and thereby stretching the springs so as to add tension thereto and store additional mechanical energy or releasing the springs or even compressing them to decrease tension and dissipate mechanical energy. The panel 42 includes a cover plate 58 connected thereto via an attachment link 57 as well as the backing plate 59 on its rear side 61 opposite its inner surface 48. Each panel 42 is connected to a respective bracket member 38.

The actuator 50 permits spring tension adjustment to be variable according to the size of user-load. The actuator 50 can be manually or automatically operated as can be contemplated by a skilled artisan. In this example, the actuator 50 is in the form of a screw mounted within a tubular socket 54 of a plate member 48a that is complementarily threaded so that turning of the screw 50 causes the threaded tubular socket to in a given direction (depending on the rotational direction of the screw 50) along the length of the screw thereby moving the plate member 48a towards or away from the other plate member 48b.

The plate member 48b is mounted to the panel 42 at its middle aperture 56 via a fastener assembly 51 which allows the plate member 48b some mechanical slack at its lateral ends. The plate 48b is also fastened to the backing plate 59 via the fastener assembly 51 through a hole 55 at a spiral groove 53 formed on the panel 42.

Therefore, each actuator 28 is connected to a bracket member 38 which is connected to the backing plate 59 on the rear side 61 of the panel 42 at the spiral groove 53. The brackets 38 are mounted at each lateral side 22 of the movable support 12. As the actuator 28 moves the brackets 38 and in turn the movable support 12 between folded down or up positions (i.e. open/closed positions), the backing plate 59 is rotated about the fastener assembly 51. The open/closed rotational movement of user load with a backing plate 59 is translated as extending or contracting action to the springs with by plates 48a and 48b. Specifically, backing plate 59 acts on plate 48b. The plate 59 not only pivots about the fastener assembly 51 but it also slides along the groove 53 along with the fastener assembly 51 and with the plate 48b during the lifting of the support 12 and mattress 14 or the lowering of the support 12 and mattress 14. As such, during lifting as the plate 48b moves along the groove 53 it stretches the springs 44 which increases tension energy that is transmitted to the actuator 28, allowing for smaller actuators to lift heavier weights.

The strength adjustment devices 40 stores mechanical energy as described above which is transferred to the bracket members 38 (via plate 48b and the backing plate 59) and a such to the actuators 28 reducing the mechanical energy for the actuators 28 to act on bracket members 38 which in turn act on the movable support 12 and mattress 14 when moving the support 12 and mattress 14 between the folded up (closed) and folded down (open) positions.

The number of springs and their tension is modulated depending on the weight of the support/mattress.

Turning now to FIG. 8, there is shown a device 60 for modulating the movement of the automated wall bed 10. The device 60 includes a sensor 62 for being mounted to the bed 10 such as the support 12 or mattress 14 for example and for detecting the weight on the mattress 14. The sensor is in communication with a controller 64 (such a microprocessor for example). The controller receives information regarding the detected from sensor 62 and compares this detected weight to a predetermined weight stored in memory of controller 64. The controller 64 is also in communication with the bed 10, particularly with the movement imparting device 20. If during movement of the movable support 12 and mattress 14 from the folded down position to the folded up position, an additional weight is detected on the mattress 14 by sensor 62 (such a child sitting on the bed during movement), this information is communicated to the controller which processes this information and communicates a sign to the movement imparting device 20 to stop the lifting movement from the folded down to the folded up poison (as such avoiding an accident).

The controller 64 may be placed in communication with a master controller 66 for receiving information regarding the functionality and condition of the automated wall bed 10 and as such providing immediate repair or maintenance services.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. An automated wall bed comprising:
a movable support defining opposite lateral sides and head and foot ends for supporting a mattress thereon;
a movement imparting device for moving the movable support between a folded up position and an folded down position;
a bracket assembly mounted to each lateral side of the movable support and in communication with the movement imparting device, the bracket assembly comprising a strength-adjustment device comprising springs for storing mechanical energy,
wherein when moving the movable support between the folded up and folded down positions, the strength-adjustment device provides mechanical energy to the movement imparting device, thereby providing for less mechanical energy to be used by the movement imparting device.

2. An automated wall bed according to claim 1, further comprising:
a sensor for sensing a predetermined weight on the mattress; and
a controller in communication with the movement imparting device and the sensor for receiving the weight amount detected by the sensor and for controlling the movement imparting device based on the detected weight,
wherein the controller provides for stopping the movement imparting device from moving the movable support from the folded down position to the folded up position when the predetermined weight is detected.

3. An automated wall bed according to any one of claim 1 or 2, wherein the strength-adjustment device provides for modulating the amount of mechanical energy provided to the movement imparting device by increasing or decreasing the tension on the springs.

4. An automated wall bed according to any one of claims 1 to 3, wherein the movement imparting device comprises a pair of actuators and the bracket assembly comprises a pair of bracket device, each bracket device being mounted to a respective lateral side of the movable support, each actuator being mounted to a respective bracket assembly.

5. An automated wall bed according to claim 4, wherein each bracket device comprises a panel with springs mounted thereto, the strength adjustment device comprising a plate assembly being mounted to the springs, the plate assembly being selectively movable for stretching the springs so as to add tension thereto thereby storing additional mechanical energy.

6. An automated wall bed according to claim 5, wherein the plate assembly comprises a pair of plate members, each plate member is mounted to a respective opposite end of the springs, at least one of the plate members being movable along the panel for stretching the springs.

7. An automated wall bed according to any one of claim 5 or 6, wherein the strength adjustment device comprises an actuator provides for selectively moving the plate assembly so as to selectively adjust the tension of the springs.

8. An automated wall bed according to claim 7, wherein the actuator comprises a threaded screw within a tubular socket of the plate assembly, the tubular socket being complementary threaded so that turning of the screw causes the tubular socket to move along the length of the screw thereby moving the plate assembly.

9. An automated wall bed comprising:
a movable support defining opposite lateral sides and head and foot ends for supporting a mattress thereon;
a movement imparting device for moving the movable support between a folded up position and an folded down position;
a sensor for sensing a predetermined weight on the mattress; and
a controller in communication with the movement imparting device and the sensor for receiving the weight amount detected by the sensor and for controlling the movement imparting device based on the detected weight,
wherein the controller provides for stopping the movement imparting device from moving the movable support from the folded down position to the folded up position when the predetermined weight is detected.

10. An automated wall bed according to claim 9, further comprising:
a bracket assembly mounted to each later side of the movable support and in communication with the movement imparting device, the bracket assembly comprising a strength-adjustment device comprising springs for storing mechanical energy,
wherein when moving the movable support between the folded up and folded down positions, the strength-adjustment device provides mechanical energy to the movement imparting device, thereby providing for less mechanical energy to be used by the movement imparting device.

11. An automated wall bed according to claim 10, wherein the strength-adjustment device provides for modulating the amount of mechanical energy provided to the movement imparting device by increasing or decreasing the tension on the springs.

12. An automated wall bed according to any one of claims 10 to 11, wherein the movement imparting device comprises a pair of actuators and the bracket assembly comprises a pair of bracket device, each bracket device being mounted to a respective lateral side of the movable support, each actuator being mounted to a respective bracket assembly.

13. An automated wall bed according to claim 12, wherein each bracket device comprises a panel with springs mounted thereto, the strength adjustment device comprising a plate assembly being mounted to the springs, the plate assembly being selectively movable for stretching the springs so as to add tension thereto thereby storing additional mechanical energy.

14. An automated wall bed according to claim 13, wherein the plate assembly comprises a pair of plate members, each plate member is mounted to a respective opposite end of the springs, at least one of the plate members being movable along the panel for stretching the springs.

15. An automated wall bed according to any one of claim 13 or 14, wherein the strength adjustment device comprises an actuator provides for selectively moving the plate assembly so as to selectively adjust the tension of the springs.

16. An automated wall bed according to claim 15, wherein the actuator comprises a threaded screw within a tubular socket of the plate assembly, the tubular socket being complementary threaded so that turning of the screw causes the tubular socket to move along the length of the screw thereby moving the plate assembly.

17. A kit for an automated wall bed comprising:
a movable support defining opposite lateral sides and head and foot ends for supporting a mattress thereon;
a movement imparting device for moving the movable support between a folded up position and an folded down position;
a bracket assembly for being mounted to each later side of the movable support and in for being placed in communication with the movement imparting device, the bracket assembly comprising a strength-adjustment device comprising springs for storing mechanical energy,
wherein when moving the movable support between the folded up and folded down positions, the strength-adjustment device provides mechanical energy to the movement imparting device, thereby providing for less mechanical energy to be used by the movement imparting device.

18. A kit for an automated wall bed according to claim 17, further comprising:
a sensor for sensing a predetermined weight on the mattress; and
a controller for being placed in communication with the movement imparting device and the sensor for receiving the weight amount detected by the sensor and for controlling the movement imparting device based on the detected weight,
wherein the controller provides for stopping the movement imparting device from moving the movable support from the folded down position to the folded up position when the predetermined weight is detected.

19. A kit fir an automated wall bed according to any one of claim 17 or 18, wherein the strength-adjustment device provides for modulating the amount of mechanical energy provided to the movement imparting device by increasing or decreasing the tension on the springs.

20. A kit for an automated wall bed according to any one of claims 18 to 19, wherein the movement imparting device comprises a pair of actuators and the bracket assembly comprises a pair of bracket device, each bracket device being mounted to a respective lateral side of the movable support, each actuator being mounted to a respective bracket assembly.

21. A kit for an automated wall bed according to claim 20, wherein each bracket device comprises a panel with springs mounted thereto, the strength adjustment device comprising a plate assembly being mounted to the springs, the plate assembly being selectively movable for stretching the springs so as to add tension thereto thereby storing additional mechanical energy.

22. A kit for an automated wall bed according to claim 21, wherein the plate assembly comprises a pair of plate members, each plate member is mounted to a respective opposite end of the springs, at least one of the plate members being movable along the panel for stretching the springs.

23. A kit for an automated wall bed according to any one of claim 21 or 22, wherein the strength adjustment device comprises an actuator provides for selectively moving the plate assembly so as to selectively adjust the tension of the springs.

24. A kit for an automated wall bed according to claim 23, wherein the actuator comprises a threaded screw within a tubular socket of the plate assembly, the tubular socket being complementary threaded so that turning of the screw causes the tubular socket to move along the length of the screw thereby moving the plate assembly.

25. A kit for an automated wall bed comprising:
a movable support defining opposite lateral sides and head and foot ends for supporting a mattress thereon;
a movement imparting device for moving the movable support between a folded up position and an folded down position;
a sensor for sensing a predetermined weight on the mattress; and
a controller for being placed in communication with the movement imparting device and the sensor for receiving the weight amount detected by the sensor and for controlling the movement imparting device based on the detected weight,
wherein the controller provides for stopping the movement imparting device from moving the movable support from the folded down position to the folded up position when the predetermined weight is detected.

26. A kit for an automated wall bed according to claim 25 further comprising:
a bracket assembly for being mounted to each later side of the movable support and in communication with the movement imparting device, the bracket assembly comprising a strength-adjustment device comprising springs for storing mechanical energy,
wherein when moving the movable support between the folded up and folded down positions, the strength-adjustment device provides mechanical energy to the movement imparting device, thereby providing for less mechanical energy to be used by the movement imparting device.

27. A kit of an automated wall bed according to claim 26, wherein the strength-adjustment device provides for modulating the amount of mechanical energy provided to the movement imparting device by increasing or decreasing the tension on the springs.

28. A kit for an automated wall bed according to any one of claims 25 to 27, wherein the movement imparting device comprises a pair of actuators and the bracket assembly comprises a pair of bracket device, each bracket device being mounted to a respective lateral side of the movable support, each actuator being mounted to a respective bracket assembly.

29. A kit for an automated wall bed according to claim 28, wherein each bracket device comprises a panel with springs mounted thereto, the strength adjustment device comprising a plate assembly being mounted to the springs, the plate assembly being selectively movable for stretching the springs so as to add tension thereto thereby storing additional mechanical energy.

30. A kit for an automated wall bed according to claim 28, wherein the plate assembly comprises a pair of plate members, each plate member is mounted to a respective opposite end of the springs, at least one of the plate members being movable along the panel for stretching the springs.

31. A kit for an automated wall bed according to any one of claim 29 or 30, wherein the strength adjustment device comprises an actuator provides for selectively moving the plate assembly so as to selectively adjust the tension of the springs.

32. A kit for an automated wall bed according to claim 31, wherein the actuator comprises a threaded screw within a tubular socket of the plate assembly, the tubular socket being complementary threaded so that turning of the screw causes the tubular socket to move along the length of the screw thereby moving the plate assembly.

33. A device for assisting the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the device comprising:
a bracket assembly mounted to each later side of the movable support and in communication with the movement imparting device; and
a strength-adjustment device in communication with the bracket assembly comprising springs for storing mechanical energy,
wherein when moving the movable support between the folded up and folded down positions, the strength-adjustment device provides mechanical energy to the movement imparting device, thereby providing for less mechanical energy to be used by the movement imparting device.

34. A device according to claim 33, wherein the strength-adjustment device provides for modulating the amount of mechanical energy provided to the movement imparting device by increasing or decreasing the tension on the springs.

35. A device for imparting a movement to an automated wall bed between folded up and folded down positions, the automated wall bed comprising a movable support defining opposite lateral sides and head and foot ends for supporting a mattress thereon, the device comprising:
an actuator;
a bracket assembly mounted to each later side of the movable support and in communication with the actuator; and
a strength-adjustment device in communication with the bracket assembly comprising springs for storing mechanical energy,
wherein when moving the movable support between the folded up and folded down positions, the strength-adjustment device provides mechanical energy to the actuator, thereby providing for less mechanical energy to be used by the movement imparting device.

36. A device according to claim 35, wherein the strength-adjustment device provides for modulating the amount of mechanical energy provided to the actuator by increasing or decreasing the tension on the springs.

37. A device for modulating the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the device comprising:
a sensor for sensing a predetermined weight on the mattress; and
a controller for being placed in communication with the movement imparting device and the sensor for receiving the weight amount detected by the sensor and for controlling the movement imparting device based on the detected weight,
wherein the controller provides for stopping the movement imparting device from moving the movable support from the folded down position to the folded up position when the predetermined weight is detected.

38. A method for assisting the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the method comprising:
storing mechanical energy in springs positioned on a support member;
placing the support member with the springs in communication with the movement imparting device and the movable support so as to transfer the mechanical energy to the movement imparting device, thereby providing for less mechanical energy to be used by the movement imparting device.

39. A method according to claim 18, further comprising:
selectively adjusting the tension on the springs so as to modulate the amount of mechanical energy provided to the movement imparting.

40. A method for modulating the movement of an automated wall bed between folded up and folded down positions, the automated wall bed comprising a movable support defining opposite lateral sides and head and foot ends for supporting a mattress thereon and a movement imparting device for moving the movable support between the folded up position and the folded down position, the method comprising:
automatically sensing the weight on the mattress;
automatically comparing the sensed weight with a predetermined weight;
automatically stopping the movement imparting device from moving the movable support from the folded down position to the folded up position when the predetermined weight is detected.
